(19) United States
(12) Patent Application Publication
(10) Pub. No.: US 2010/0270757 A1
(43) Pub. Date: Oct. 28, 2010

(54) TOOL COOLANT APPLICATION AND DIRECTION ASSEMBLY

(76) Inventor: Kevin Beckington, Ann Arbor, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/791,168

(22) Filed: Jun. 1, 2010

Related U.S. Application Data
(63) Continuation-in-part of application No. 11/636,012, filed on Dec. 7, 2006, now Pat. No. 7,785,046.
Application No. 11/636,012 is a continuation-in-part of application No. 11/098,979, filed on Apr. 5, 2005, now abandoned.
Application No. 11/098,979 is a continuation-in-part of application No. 10/197,390, filed on Jul. 17, 2002, now Pat. No. 7,134,812.

(51) Int. Cl. B23C 5/28; B23C 5/26; B23P 15/00

(52) U.S. Cl. 279/20; 407/11; 29/428

(57) ABSTRACT

A tool holder includes an insert having an annular channel in fluid communication with an inlet. The insert mounts within a body that provides for rigidly mounting the tool to the machine. Coolant flow through the inlet and annular channel exits the insert through passages directing coolant fluid along the axis of the tool. The passages are annularly disposed about a face of the insert for directing coolant fluid along the tool.

### REFERENCE TO RELATED APPLICATIONS

This application is a continuation-in-part of U.S. patent application Ser. No. 11/636,012 filed Dec. 7, 2006 which is continuation-in-part of co-pending U.S. application Ser. No. 11/098,979 filed on Apr. 5, 2005 which is a continuation-in-part of U.S. application Ser. No. 10/197,390 filed on Jul. 17, 2002, now U.S. Pat. No. 7,134,812, issued on Nov. 14, 2006.

### BACKGROUND OF THE INVENTION

This disclosure relates to a tool holder that includes features for directing coolant flow onto a tool workpiece interface. More specifically, this disclosure relates to a tool holder that includes openings that directs coolant flow to maintain a desired fluid flow rate at the tool workpiece interface regardless of tool rotational speed.

Conventional machining process may utilize a stream of coolant directed onto the cutting tool to maintain a constant temperature. Without coolant flow, friction from the tool and the workpiece generate heat of a degree sufficient to decrease tool life. Further, machining produces metal chips that are preferably evacuated from the machining area in order to prevent damage to the tool and work piece. The stream of coolant aids evacuation of metal chips from the work piece during machining.

Typical arrangements for directing coolant onto a tool include the use of a plurality of hoses arranged to direct fluid onto the tool. These hoses are typically of a semi-rigid design extending around a tool and manually positioned to direct coolant onto a tool. Often during the machining, the work piece or chips bump and contact the coolant lines changing the position of the hose such that the coolant is no longer directed as originally positioned onto the tool. In addition, hoses are often not positionable for providing coolant as desired when machining of relatively deep openings or holes. Further, in some part configurations an adjustable coolant hose is simply not feasible and does not supply and direct coolant flow adequately to the tool.

Known tool holders flow coolant into a tool and workpiece interface. Disadvantageously, the forces rotating the tool spray the cooling fluid outwardly away from the tool workpiece interface. Accordingly, merely spraying fluid out of a tool does not provide the desired benefits. Instead, much of the cooling fluid is wasted as being sprayed outside of the tool workpiece interface. In some instances an increased pump pressure is utilized in an effort to overcome these deficiencies. However, such efforts cannot overcome the inefficiencies inherent in prior art designs.

### SUMMARY OF THE INVENTION

An example tool holder secures a tool and includes an insert that defines passages for directing coolant onto a tool during machining operations.

An example tool holder includes an insert within an annular channel in fluid communication with an inlet defined by the insert pressed into the face of the tool holder. The insert mounts within a body that provides for rigidly mounting the tool to the machine. Coolant flows through the inlet and internal channels to exit the insert through passages directing coolant fluid along the axis of the tool.

Accordingly, the example tool holder provides easy mounting to existing machinery while directing coolant along the entire length of a tool without complex piping and valving and does not interfere with the work piece tool interface during machining.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 is a partial cross-sectional view of an example tool holder.

FIG. 2 is an enlarged sectional view of the example tool holder.

FIG. 3 is a front view of the example tool holder.

FIG. 4 is a cross-sectional view of a front portion of the example tool holder.

FIG. 5 is a front view of an example insert.

FIG. 6 is a side sectional view of the example insert.

FIG. 7 is an enlarged view of a portion of the example insert.

FIG. 8 is a schematic view of flow passages of the example tool holder.

### DETAILED DESCRIPTION OF THE PREFERRED EMBODIMENT

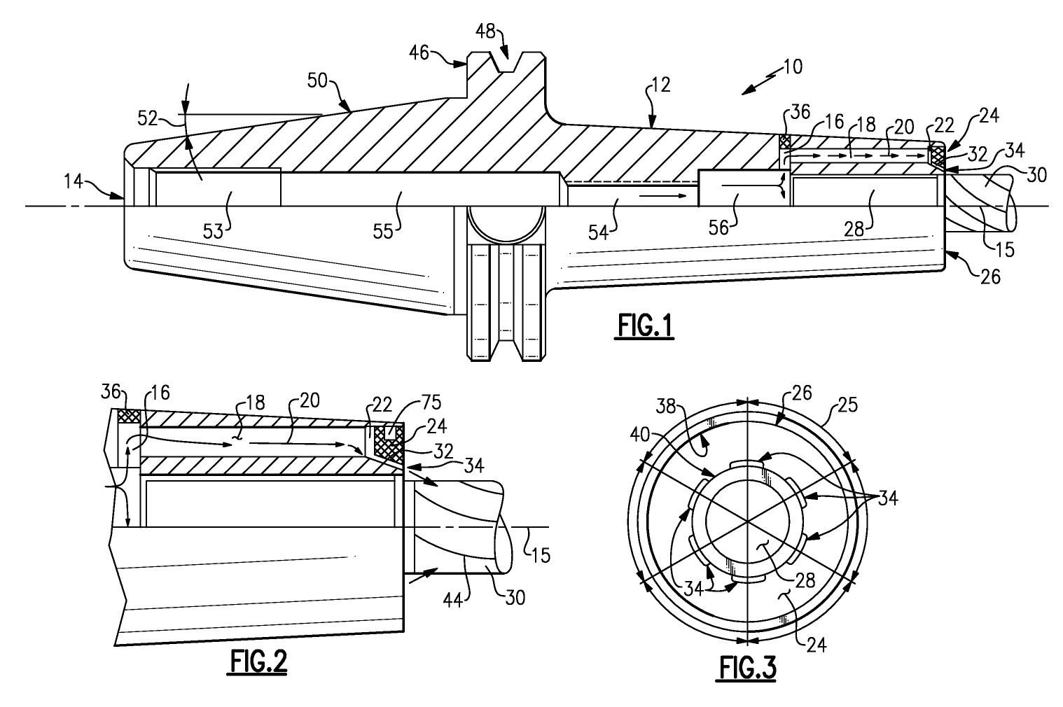

Referring to the FIG. 1, an example tool holder assembly 10 holds a tool 30 for mounting with a machine tool (not shown). The example tool holder 10 is an end mill holder, however other tool holders as are known will benefit from the disclosures herein. The tool holder 10 includes a body 12 having an inlet 14 through which coolant (indicated by arrows 20) flows to lateral passages 16 that are in turn in fluid communication with coolant passages 18. Although the example tool holder assembly 10 includes an inlet through a rear portion, coolant may also be introduced through other portions of the tool holder 10, such as for example through a flange portion 46. The coolant passages 18 are in fluid communication with and annular fluid channel 22. The annular fluid channel 22 is in turn in fluid communication with passages 32 defined by an insert 24 and a conical wall 40. Coolant directed through the passage 32 exits through ports 34 at a desired angle and velocity to impact the tool 30. The direction and velocity are determined by the example configuration of the passages 32 and ports 34.

Conventional tools that include flow through coolant features are inefficient and provide little benefit. This is so because rotation of the tool holder generates centrifugal forces that act on the coolant flow leaving openings. The centrifugal forces drive the coolant outward and away from the tool workpiece interface. The example disclosed features provides for coolant to be directed as is required to counteract the centrifugal forces and provide coolant at the tool workpiece interface.

The example tool holder 10 includes the mounting flange 46 including a groove 48. From the mounting flange 46 back toward the inlet 14 is a tapered portion 50 that is tapered at a desired angle 52. The desired angle is a feature specified to allow mounting of the tool holder 10 is specifically configured machines. Moreover, the specific configuration of the flange 46 further provides the required dimensions to provide for mounting in a desired machine tool.

The example tool holder 10 includes a cavity 28 that receives the tool 30. The example cavity 28 provides a thermal fit mounting of the tool 30. Heating the upper portion of the tool holder 10 expands the cavity 28 allowing insertion of the tool 30. Subsequent cooling causes the cavity body 12 to contract around the tool 30 for a secure fit. Moreover, although thermal fit mounting is disclosed, other mounting configurations such as using fasteners to secure the tool within the bore are also within the contemplation and scope of this disclosure.

The cavity 28 is in communication with the fluid inlet 14 on a rear end of the tool holder 10 through cavities 53, 54, 55, and 56. The cavities 53, 54, 55, and 56 are all in fluid communication with each other and the inlet 14, and lateral passages 16.

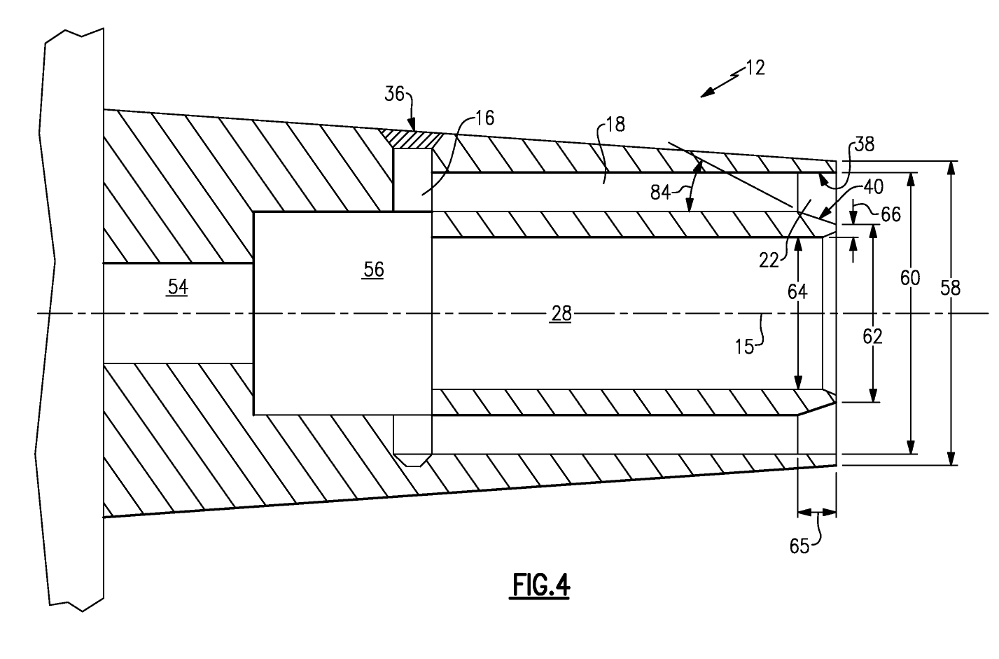

Referring to FIGS. 2 and 3 with continued reference to FIG. 1, the tool face 26 includes an opening for the tool 30 and also ports 34 through which coolant is ejected onto cutting surfaces 44 of the tool 30. The insert 24 is mounted within the annular channel 22. The example insert 24 is held within the annular channel 22 by a brazed connection. As appreciated, other welding, and/or brazing techniques may also be utilized within the scope of this disclosure. The annular channel 24 is defined at the front face 26 of the tool holder 10 by a first wall 38 and a conical wall 40. The conical wall 40 is spaced radially inward of the first wall 38. The ports 34 are defined in the insert 24 and are equally spaced circumferentially a distance 25 about an inner diameter of the insert 24.

Referring to FIG. 4, the body 12 includes the cavity 28 for the tool 30 along with other cavities (54 and 56 shown here) formed to define the coolant flow path through the tool body 12. The body 12 includes the lateral passage 16 that connects the cavity 56 with the longitudinal channel 18. In this example the lateral passage 16 is formed from one side and extends past the cavity 56 to provide for an intersection with the passage 18. A plug 36 is then welded, threaded or otherwise fixed within the lateral channel 16. The passage 18 is disposed radially outside of the cavity 28 for the tool 30. Accordingly, coolant is not required to flow around the tool to reach the face 26. The cavity 18 terminates in communication with the annular channel 22. The annular channel 22 is defined on a radially outer side by the first wall 38. The conical wall 40 defines the opposite and radially inward side of the annular channel 24. The conical wall 40 is angled inwardly toward the axis 15 a desired angle 84. In the disclosed example, the angle 84 is 10°. Moreover, in the disclosed example the conical wall 40 may include an angle 84 between 5° and 15°.

The cavity 28 includes an inner diameter 64 that is determined to fit a specific tool diameter. As appreciated, the size of the inner diameter 64 is as known to provide the desired thermal fit with the tool 30. The inner diameter 64 therefore may vary as is known to accommodate tool sizes of standard and custom sizes.

The conical wall 40 is spaced a radial distance 66 from the inner diameter 64. Accordingly, the smallest diameter at the tip of the conical wall 40 as is indicated at 62 is spaced apart from any tool mounted within the cavity 28. The distance from the cavity 28 and thereby the tool 30 provides for a desired alignment of coolant flow on the surface of the tool 30. Moreover, the diameter 62 will vary with the diameter 64. The first wall 38 is disposed at a diameter 60 that is larger than the diameter 62 to define the annular channel 24. As appreciated, the difference in the diameter 60 and 62 define the radial width of the annular channel 24, and thereby the insert 24 that is mounted therein. The overall diameter 58 of the tool holder is spaced radially further outward and represents the largest diameter of the tool holder 10. Because the insert 24 is fixed by a welding or brazing process within the annular channel 24, no other external securing means is required. This provides for a low profile and low interference face 26 of the example tool holder 10. The smaller profile provides for use of the tool holder 26 in applications not feasible for tool holders with larger structures mounted to the forward most face 26.

The example annular channel 22 is generated at a depth 65. The depth 65 is determined based on a desired length of the passage 32 to the ports 34. The length and size of each of the passages 32 is determined to provide a desired angle and velocity of coolant to counter the centrifugal forces generated during rotation of the tool holder 10.

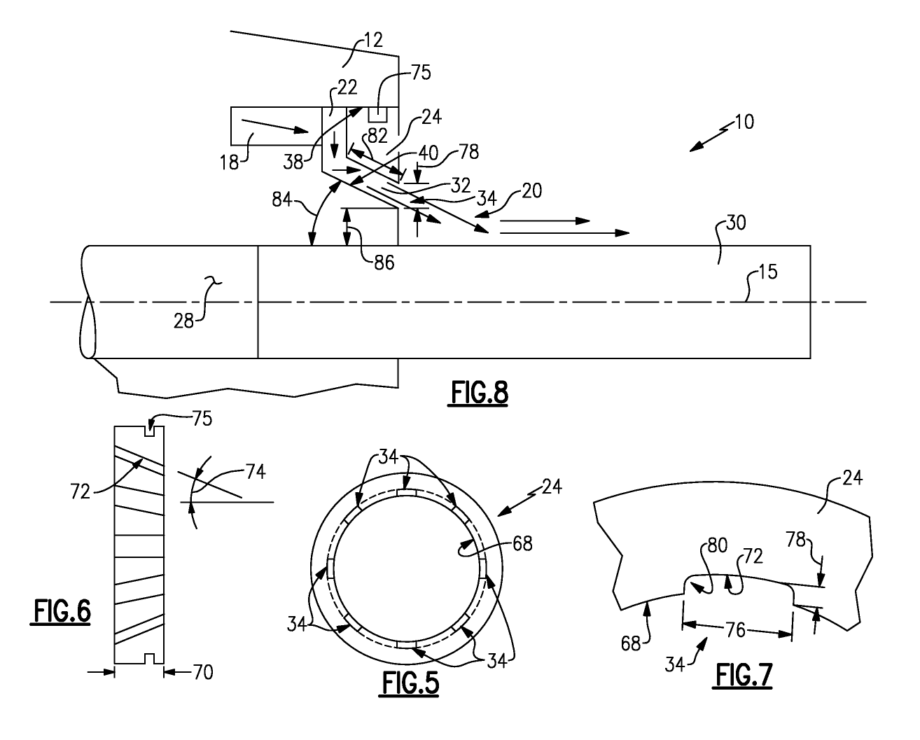

Referring to FIGS. 5, 6 and 7, the example insert 24 includes a thickness 70 that corresponds with the depth 65 to define the annular channel 22 (FIGS. 2 and 8). The depth of the annular channel 22 is determined to provide sufficient flow capacity to the ports 34 to allow the desired flow velocity of coolant. The ports 34 are grooves on an inner surface 68 of the insert 24. The grooves 34 include a circumferential length 76 that is greater than a radial height 78 to provide a generally rectangular groove. The grooves includes radial corners 80 and are of a specific defined area determined to provide the required coolant flow volume and velocity given a pressure produced by a coolant pump (not shown). The overall area provided by all of the grooves is factored given a desired pump capacity and the desired coolant velocity upon exiting the ports 34. As appreciated, the ports 34 may include other shapes and configurations that provide the desired coolant flow. The example insert 24 includes eight ports, however other numbers of ports could also be utilized within the scope and contemplation of this disclosure.

The example ports 34 (grooves) include an angled inner surface 72. The angled inner surface 72 is disposed at an angle 74 that matches the angle 84 (FIGS. 4 and 8) of the conical wall 40. Because the conical wall 40 and the inner surface 72 of the ports 34 defined by the insert 24 are the same, the passage 32 includes parallel walls. The parallel walls provided by the common angle of the ports 34 and the conical walls 40 provide an alignment of coolant flow that substantially reduces turbulent flows that reduce velocity and coolant effectiveness.

The example insert 24 includes a groove 75 for a brazing wire material. During assembly of the tool holder 10, brazing material in the form of a wire is received within the groove 75. The inset 24 is then placed within the annular cavity 22 with a light press fit and brazed in place. The brazing of the insert within the annular cavity 22 provides a substantially permanent fit. As appreciated, other welding techniques may also be utilized within the scope and contemplation of this disclosure.

Referring to FIG. 8, the example tool holder 10 includes the corresponding conical wall 40 and inner surfaces 72 of the insert 24 to define parallel walls of the passage 32. Because the walls of the passage 32 are parallel, coolant flow does not develop excessive turbulence that disrupts coolant flow emitted from the ports 34. Excessive turbulent flow from the ports 34 can cause a spraying effect of the coolant that does not provide efficient cooling. Instead, the example passage 32 provides a laminar flow that directs coolant at velocity to the tool workpiece interface. The passage 32 is further included with a first length 82 that is determined to provide the desired flow characteristics. The first length 82 is that length in which the inner surface 72 of the insert 24 and the conical wall 40 are parallel to each other. The first length 82 is related to the width 78 of the ports 34 and the angle 84 at which the passage 32 is arranged relative to the axis 15. In this example the first length 82 is determined according to a relationship between the width 78 and angle 84 according to the following relationship.

L>0.75 (W/tan A),

### Where:

L=the first length
W=a width of the coolant opening 78 perpendicular to the axis, and
A=the angle 84 of the passage relative to the axis 15. With this relationship, the desired length of the passage 32 is determined. Once the first length 82 is determined the other features of the insert 24 and annular channel 22 are determined to create the configuration at the front face 26 of the tool holder.

The ports 34 are spaced a distance 86 away from the tool 30 to apply coolant to the cutting surfaces of the tool. The distance 86 is the distance beginning at the outer circumference of the cavity 28 and ending at the radially innermost edge of the port 34. The port 34 location relative to the tool 30 provides for the creation of coolant velocity and inertia that overcome centrifugal forces. In this example the distance 86 is between 0.03 and 0.25 inches away from the outer surface of the cavity 28 and thereby the tool 30.

The parallel walls that define the passage 32 stabilize coolant flow. Moreover, the passage 32 stabilizes and directs coolant flow by overcoming and directing the inertia within the coolant flow caused by flowing through other coolant passages of the tool holder 10. As appreciated, inertia forces of coolant flow influence the character of flow emitted from the ports 34. In the disclosed example, such inertial effects are neutralized by the defined location and size of the passage 32. In other words, turbulence and inertia produced in the coolant as it flows through the lateral passages 16 and into through the annular channel 22 are neutralized by defining a unidirectional, parallel walled passage 32 prior to exiting through the ports 34.

Moreover, maximizing the velocity of the coolant flow exiting the ports 34 increases the energy available to counteract centrifugal forces encountered during operation. This is accomplished by limiting loses due to turbulent flows. The passage 32 substantially eliminates such turbulence by creating laminar flow for the first length prior to exiting the ports 34. Further, the velocity of the coolant is maintained while coverage is optimized by the example shaped rectangular ports. The elongated partial conical wall 40 and angle of the passage 32 disperses coolant about the circumference of the tool while limiting volume, thereby maintaining the velocity of the coolant flow.

Accordingly, the example tool holder provides for the increased coolant velocity and direction to overcome forces encountered during operation to efficiently direct coolant at the tool workpiece interface.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A tool holder assembly comprising;
an inlet for cooling fluid;
a body portion including an opening for fixing a tool along an axis;
an annular channel defined between a first side spaced radially inward of a second side; and
an insert mounted within the annular channel, the insert including an inner surface having grooves that cooperate with the first side of the annular channel to define a passage for coolant flow, wherein the passage for coolant flow is disposed at an angle relative to the axis.

2. The assembly as recited in claim 1, wherein the passage includes a first length wherein the first side of the body portion and the inner surface of the insert are parallel to each other.

3. The assembly as recited in claim 2, wherein the first length terminates at a coolant opening for the coolant flow.

4. The assembly as recited in claim 2, wherein the first length is determined according the relationship:
L>0.75 (W/tan A),
where: L=the first length
W=a width of a coolant opening perpendicular to the axis, and
A=to the angle of the passage relative to the axis.

5. The assembly as recited in claim 3, wherein the coolant opening is spaced apart from the opening for the tool a distance.

6. The assembly as recited in claim 3, wherein the coolant opening comprises a groove having a circumferential width greater than a radial height.

7. The assembly as recited in claim 6, wherein the coolant opening comprises a plurality of coolant openings, with each opening including a circumferential width greater than a radial height.

8. The assembly as recited in claim 1, wherein the passage is disposed at an angle between 5 and 15 degrees relative to the axis.

9. The assembly as recited in claim 1, wherein the insert is permanently attached to the body portion within the annular channel.

10. An end mill holder comprising:
a body including a mounting flange and a tapered portion adapted for mounting into a machine, the body further including an inlet for coolant;
a central cavity centered about an axis within the body for receiving a cutting tool;
an annular channel disposed at a front most portion of the body, the annular channel defined between a conical wall spaced radially inward of an outer wall; and
an insert mounted within the annular channel and including an inner surface parallel with the inner conical wall to define a passage for coolant flow that is angled relative to the axis.

11. The end mill holder as recited in claim 10, wherein the inner surface of the insert comprises at least one groove that defines an opening for the coolant flow.

12. The end mill holder as recited in claim 11, wherein the at least one groove defines the opening that includes a circumferential length greater than a radial length.

13. The end mill holder as recited in claim 11, wherein the at least one groove comprises a plurality of grooves spaced apart from each other circumferentially equal distances.

14. The end mill holder as recited in claim 10, wherein the passage comprises a first length and within the first length, the inner surface of the insert is parallel to the conical wall.

15. The end mill holder as recited in claim 14, wherein the first length is related to an angle of the passage and a width of the opening through which coolant flows according to the relationship:
L>0.75 (W/tan A),
where: L=the first length
W=a width of the coolant opening perpendicular to the axis, and
A=to the angle of the passage relative to the axis.

16. The end mill holder as recited in claim 10, wherein the conical wall is spaced a radial distance from the central cavity for receiving a cutting tool.

17. The end mill holder as recited in claim 16, wherein the radial distance between the central cavity and the conical wall is within a range of 0.03 to 0.25 inches.

18. The end mill holder as recited in claim 15, where the conical wall is angled between 5 and 15 degrees from the axis.

19. A method of building a tool holder for supporting a cutting tool comprising:
forming a central cavity within a tool body for holding a cutting tool along a longitudinal axis;
creating an annular channel in a front face of the body portion, the annular channel defined by a conical wall spaced radially inward of an outer wall;
defining a passage through the body for supplying coolant to the annular channel; and
mounting an insert into the annular channel, the insert including at least one inner surface parallel with the conical wall that defines at least one passage for coolant between the conical wall and the inner surface of the inlet that is angled relative to the longitudinal axis.

20. The method as recited in claim 19, including the step of forming the conical wall spaced apart a radial distance from the central cavity.

21. The method as recited in claim 19, including forming the at least one passage for coolant between the conical wall and the inner surface to include a first length.

22. The method as recited in claim 19, including the step of determining the first length according to a relationship between an angle relative to the axis and a width of an opening for coolant defined in the insert.

23. The method as recited in claim 19, wherein the length is determined according to the relationship:
L>0.75 (W/tan A),
where: L=the first length
W=a width of a coolant opening perpendicular to the axis, and
A=to the angle of the passage relative to the axis.

24. The method as recited in claim 19, including the step of forming the at least one inner surface as a groove on an inner diameter of the insert that includes a circumferential length greater than a radial length.
